(19) United States
(12) Patent Application Publication
(10) Pub. No.: US 2010/0149038 A1
(43) Pub. Date: Jun. 17, 2010

(54) Portable Millimeter-Wave Near Field Scanner

(76) Inventors: Kenneth W. Brown, Yucaipa, CA (US); David D. Crouch, Corona, CA (US); Michael J. Sotelo, Chino, CA (US); Scott W. McClurg, Victorville, CA (US); Vince Giancola, Chino, CA (US); William E. Dolash, Montclair, CA (US)

Correspondence Address: SoCal IP Law Group LLP - Raytheon Company, 310 N. Westlake Blvd. Suite 120, Westlake Village, CA, 91362, US

(21) Appl. No.: 12/337,442

(22) Filed: Dec. 17, 2008

(51) Int. Cl. H01Q 3/00

(52) U.S. Cl. 342/360

(57) ABSTRACT

There is disclosed an apparatus to test an antenna. A transmitter generates a test signal radiated by the antenna under test. A near field scanner includes a field sampling probe to capture electromagnetic energy radiated by an antenna under test. An x-y positioning system including x and y positioning motors moves the field sampling probe over a measurement surface disposed proximate to the antenna under test. A quasi-optical beam transport system couples at least a portion of the captured electromagnetic energy from the field sampling probe to a scanner output port. A receiver is coupled to the scanner output port.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to millimeter-wave test equipment. More specifically, this invention relates to test equipment for near-field measurements of large-aperture millimeter-wave antennas.

2. Description of the Related Art

There are two primary means by which the radiating properties of aperture antennas are measured. The most widely used is the far-field antenna range. A far-field antenna range consists of a probe antenna and the antenna under test (AUT), separated by a distance of at least 2D²/λ, where D is the largest linear dimension of the AUT and λ is the wavelength at which the properties of the AUT are to be measured. The distance 2D²/λ can be substantial for a large-aperture millimeter-wave antenna. For example, for an antenna for which D=2 meters at a wavelength λ=3 mm (corresponding to a frequency of 100 GHz), the distance 2D²/λ=2.67 km. Thus far-field millimeter-wave antenna ranges suitable for use at frequencies near 100 GHz are typically located out doors such that there is an unobstructed line-of-sight of 2.7 km or more from the AUT to the probe antenna.

An alternative to a far-field antenna range is a near-field scanner. Near-field scanners first came into existence in the early 1950s, and have increased in popularity ever since. A generic planar near-field scanner consists of a probe antenna mounted on an x-y motion stage, which moves the probe antenna to different positions on a planar measurement surface, and electronic equipment for measuring and recording the amplitude and phase of the electromagnetic field received by the probe antenna as a function of the probe antenna position. The electromagnetic field radiated by the AUT is measured with the probe antenna positioned at a plurality of locations on the planar measurement surface, and the resulting measured data is analyzed to estimate the far-field performance of the AUT. As the name implies, near-field scanners measure the electromagnetic field radiated by an AUT in the near field of the AUT, so such an instrument is not subject to the requirement that the probe and the AUT be separated by a distance greater than 2D²/λ. As a result, a near-field scanner can be constructed almost anywhere.

Commonly, near-field scanners are constructed as permanent facilities, such that an antenna to be tested must be removed from the system of which it is a part and transported to the test facility. However, portable near-field scanners have been constructed, primarily for use at X band (approximately 10 GHz) and lower frequencies.

### DESCRIPTION OF THE DRAWINGS

FIG. 1 is a block diagram of an antenna test system using a near-field scanner.

FIG. 2 is a front schematic view of a near-field scanner.

FIG. 3 is a schematic diagram of a transmission path in a near-field scanner.

FIG. 4 is a matrix representation of a frequency-dependent and position-dependent two-port network.

FIG. 5 is a matrix representation of cascaded two-port networks.

FIG. 6 is a block diagram of a system to characterize a transmission path.

FIG. 7 is a flow chart of a process for testing an antenna.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

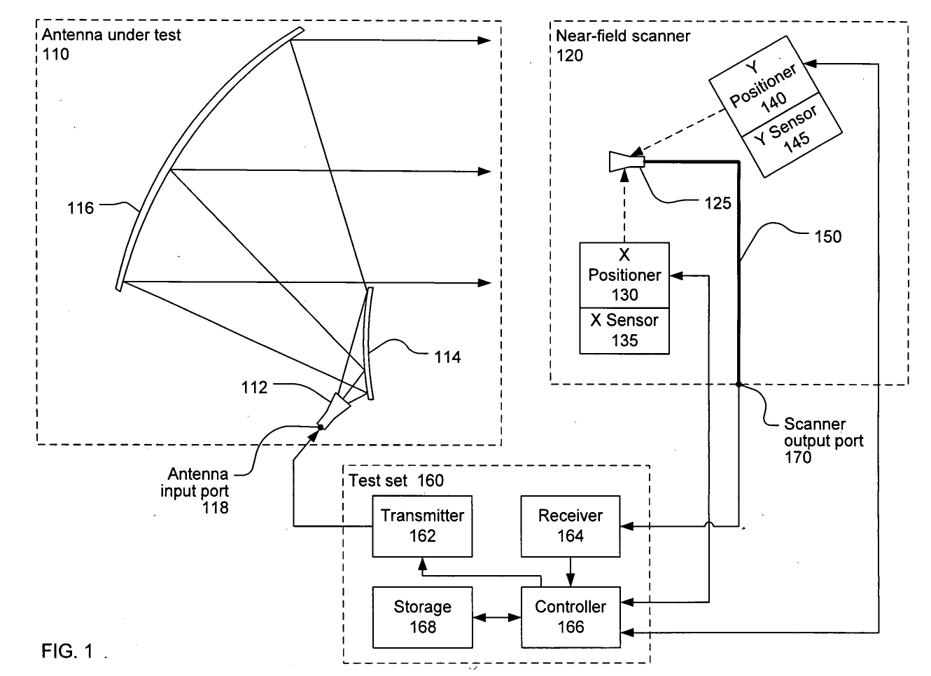

Referring now to FIG. 1, a system for testing an antenna such as antenna under test (AUT) 110 may include a near field scanner 120 and a test set 160. The AUT may have an input port 118 coupled to a transmitter 162 within the test set 160. The exemplary AUT shown in FIG. 1 is a reflector antenna including a horn radiator 112, a secondary reflector 114, and a primary reflector 116. Signals received at the antenna input port 118 may be launched into free space by the horn radiator 112 and then expanded and formed into an essentially collimated beam by the combined effect of the secondary reflector 114 and the primary reflector 116. The AUT may be any other type of antenna.

The near-field scanner 120 may include a field sampling probe 125 and an x-y positioning system including an x-axis positioner 130 and a y-axis positioner 140. The x-axis positioner 130 and the y-axis positioner 140 may be adapted to mechanically scan the location of the field sampling probe 125 over a planar measurement surface whose position and orientation with respect to the AUT are known. The planar measurement surface is a virtual surface defined by the range of motion of the field sampling probe 125. The near-field scanner 120 and the AUT may be disposed such that a substantial portion of the beam radiated from the AUT passes through the measurement surface.

The x-axis positioner 130 and the y-axis positioner 140 may be linear motion stages driven by respective motors under control of a controller 166 within the test set 160. The field sampling probe 125 may be mounted, for example, to the y-axis positioner 140, which in turn may be mounted on the x-axis positioner 130. The x-axis positioner 130 and the y-axis positioner 140 may be adapted to move the field sampling probe 125 along two orthogonal axes. The two orthogonal axis may be a vertical axis and a horizontal axis or two other orthogonal axes.

The x-axis positioner 130 and the y-axis positioner 140 may be precision motion stages capable of moving the field sampling probe 125 across the measurement surface with sufficient precision, such that any measurement errors introduced by inaccurate positioning of the field sampling probe 125 are small with respect to the allowable tolerances on the AUT. The near-field scanner 120 may include a position sensing system in addition to, or as an alternative to, high precision motion stages. The position sensing system may include independent or integrated x-axis position sensor 135 and y-axis position sensor 145. The position sensing system may also include a z-axis position sensor (not shown). The position sensors may be optical, mechanical, acoustic or other position sensors capable of measuring the position of the field sensing probe with respect to the AUT. The position sensing system may include, for example, a laser tracker or x-axis and y-axis interferometers. One or more mirrors, corner cubes, or other optical reflectors may be mounted on or near the field sampling probe 125 to allow optical measurement of the position of the field sensing probe with respect to the AUT.

The near-field scanner 120 may include a transmission path 150 to couple electromagnetic energy from the field sampling probe 125 to a scanner output port 170. The scanner output port 170 may be coupled to a receiver 164 in the test set 160. The physical location of the scanner output port 170 may remain fixed as the field sampling probe 125 is moved across the measurement plane. Thus the physical length and electrical characteristics of the transmission path 150 may change as function of the position of the field sampling probe 125.

The test set 160 may include the transmitter 162, the receiver 164, the controller 166, and a storage device 168 to store test data accumulated as the field sampling probe 125 is scanned across the measurement plane. The test set 160 may be a single apparatus or a suite of equipment. The equipment constituting the test set 160 may be co-located or may be distributed between two or more locations. The transmitter 162 and the receiver 164 may be portions of a network analyzer containing additional transmitters and/or receivers. The transmitter 162 and the receiver 164 may be portions of a two-port network analyzer adapted to measure the S-parameters, or other parameters, of a two port network. S-parameters, or scattering parameters, are commonly used to describe the properties of radio-frequency and microwave networks.

As used herein, a storage device is a device that allows for reading and/or writing to a storage medium. Storage devices include hard disk drives, DVD drives, flash memory devices, and others. The storage media that may be used within a storage device include magnetic media such as hard disks, floppy disks and tape; optical media such as compact disks (CD-ROM and CD-RW) and digital versatile disks (DVD and DVD±RW); flash memory cards; and other storage media.

The controller 166 may direct the x-axis positioner and the y-axis positioner to scan the field sampling probe 125 over the measurement plane. The controller 166 may receive data indicating the precise position of the field sampling probe with respect to the AUT from the x-axis position sensor 135 and the y-axis position sensor 145. The controller 166 may also receive measurement data from the receiver 164 and may cause data such as the measurement data and precision position data to be stored in the storage device 168. The controller may be or may include a personal computer, in which case the storage device 168 may be a hard drive or writable optical drive (CD-RW or DVD-RW) within the personal computer.

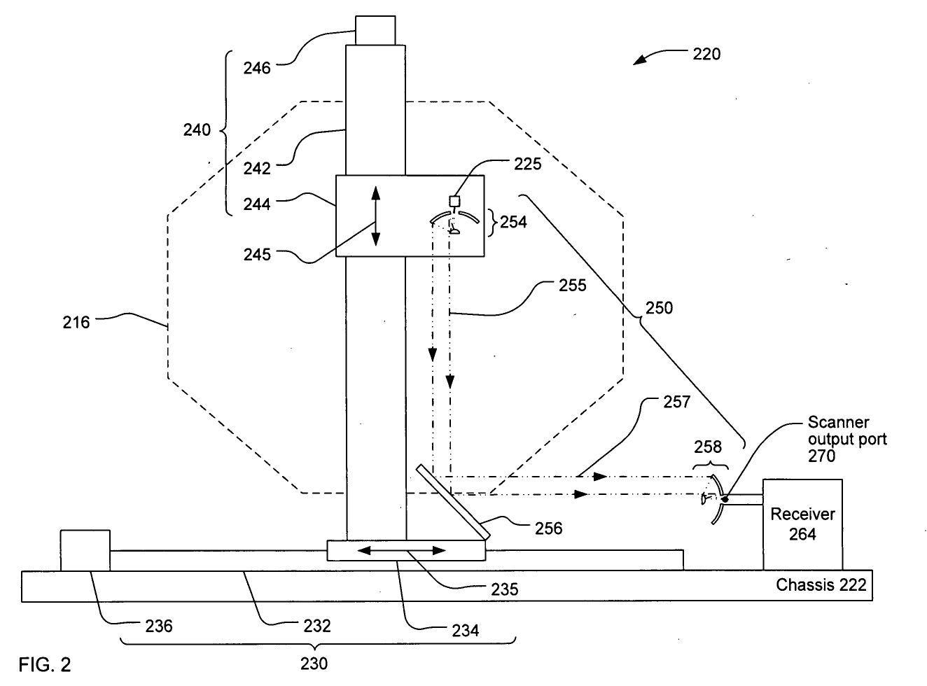

Referring now to FIG. 2, an exemplary near field scanner 220 may include an x-axis positioner 230, a y-axis positioner 240, and a field sensing probe 225. The x-axis positioner 230 may include a first rail 232, a first stage 234 movably coupled to the first rail, and a first motor 236. The first motor 236 may be coupled to the first stage 234 and/or the first rail 232 by a screw, a belt, a chain, or some other mechanism that allows the first motor 236 to cause the first stage 234 to move along the first rail 232 in a first direction as indicated by an arrow 235. The first motor 236 may be attached to and move with the first stage 234. The first motor 236 may be attached to the first rail 232. The first rail 232 may be attached to and supported by a chassis 222. The chassis 222 may be a table, a frame, a bench, or some other structure. The chassis 222 may be equipped with manually or automatically adjustable feet, legs, or other structure to level the chassis such that the first rail 232 extends in a horizontal direction.

The y-axis positioner 240 may include a second rail 242, a second stage 244 movably coupled to the second rail 242, and a second motor 246. The second motor 246 may be coupled to the second stage 244 and/or the second rail 242 by a screw, a belt, a chain, or some other mechanism that allows the second motor 246 to cause the second stage 244 to move along the second rail 242 in a second direction as indicated by an arrow 245. The second motor 246 may be attached to and move with the second stage 244. The second motor 246 may be attached to the second rail 242. The second direction 245 may be orthogonal to the first direction 235. The second rail 242 may be attached to and supported by the first stage 234 such that the second positioner 240 moves along with the first stage 234.

A field sampling probe 225 may be attached to, and move with, the second stage 244. The combined motion of the first stage 234 and second stage 244 may move the field sampling probe 225 to any position within a planar measurement surface. The measurement surface may be disposed to intersect the beam radiated from an AUT, represented by the dashed outline 216.

The field sampling probe 225 may convert the electromagnetic field radiated by the AUT into a field sample signal. In the example of FIG. 2, the field sampling probe 225 is shown as a pyramidal horn antenna. The field sampling probe 225 may be a pyramidal horn antenna, a conical horn antenna, or a corrugated horn antenna. Other types of field sampling probes may be used. The field sample signal may be coupled from the field sampling probe 225 to a scanner output port 270 over a free-space quasi-optical beam transport path 250 including a first antenna 254, a mirror 256, and a second antenna 258. The term quasi-optical is generally understood to mean an electronic signal transport system that uses high-order beam guiding components, such as lenses and shaped mirrors, for signal distribution and collection.

The first antenna 254 may be attached to, and move with, the second stage 244. The first antenna 254 may receive the field sample signal from the field sampling probe 225. The first antenna 254 may transmit the field sampling signal as a first beam 255. The first beam 255 may be essentially collimated, where the term “essentially collimated” is intended to mean collimated to the extent practical given the effects of normal manufacturing tolerances on the antenna elements and the effects of diffraction and other aberrations. The direction of propagation of the first beam 255 may be parallel to the second direction 245, which is the direction of motion of the y-axis positioner 240. The first antenna 254 may be a reflective telescope. The first antenna 254 may be a Cassegrain reflective telescope having a concave primary mirror and a convex secondary mirror.

The mirror 256 may receive the first beam 255 from the first antenna 254. The mirror 256 may be attached to and supported by the first stage 234. The mirror 256 may reflect the first beam 255 to provide a second beam 257. The second beam 257 may be essentially collimated. The direction of propagation of the second beam 257 may be parallel to the first direction 235, which is the direction of motion of the x-axis positioner 230.

The second antenna 258 may receive the second beam 257 from the mirror 256. The second antenna 258 may focus the received second beam to provide a scanner output signal at the scanner output port 270. The scanner output port may be coupled to a receiver 264. For example, the second antenna 258 may be coupled to the receiver 264 by a waveguide or other signal transmission medium. The second antenna 258 may be a reflective telescope. The second antenna 258 may be a Cassegrain reflective telescope having a concave primary mirror and a convex secondary mirror.

Since the field sampling probe 225 and the first antenna 254 move with the second stage 244, the path length of the first beam 255 may depend on the position of the second stage 244. Similarly, since the mirror 256 moves with the first stage 234, the path length of the second beam 257 may depend on the position of the first stage 234. Thus, as the field sampling probe 225 is moved across the planar measurement surface, the total length of the quasi-optical beam transport path 250 will vary. Changes in the length of the quasi-optical beam transport path 250 will consequentially cause changes in the phase of the scanner output signal at scanner output port 270 relative to the phase of the field sample signal at the field sampling probe 225. Further, since the collimation of the first beam 255 and the second beam 257 may not be perfect, changes in the length of the quasi-optical beam transport path 250 may also cause changes to the relative amplitude of the scanner output signal at scanner output port 270 compared to the amplitude field sample signal at the field sampling probe 225. Thus both the phase and insertion loss of the quasi-optical beam transport path 250 may vary with the position of the field sampling probe 225.

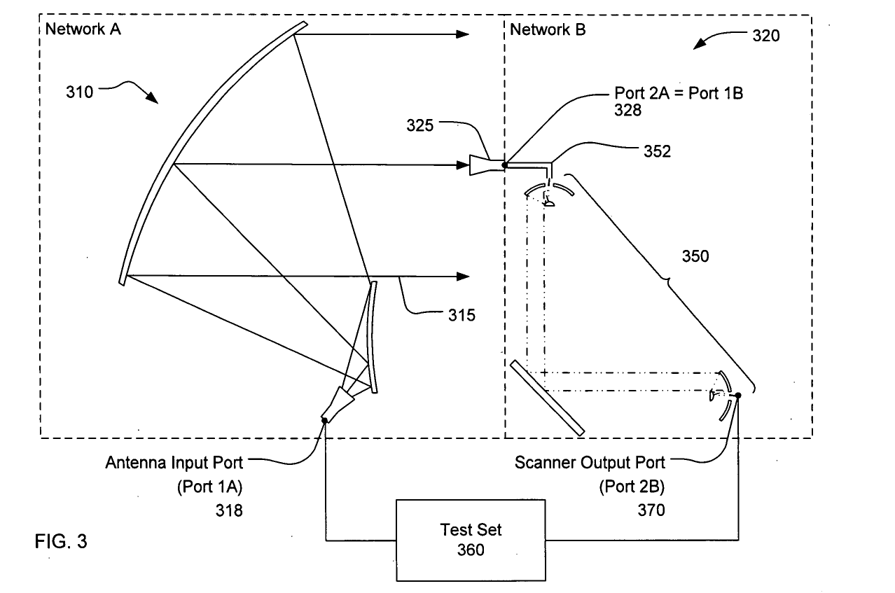

FIG. 3 is a simplified block diagram of an antenna being tested using a near-field scanner. A test set 360 may provide a signal to an input port 318 of an AUT 310. The AUT 310 may radiate a substantial portion of the signal as an output beam 315. A portion of the output beam 315 may be captured by a near-field scanner 320. Within the near-field scanner 320, a field sampling probe 325 may convert a portion of the output beam 315 into a field sample signal. The field sample signal may be coupled to a scanner output port 370. The test set 360 may receive a scanner output signal from the scanner output port 370. The test set 360 may include a vector network analyzer to measure and determine the insertion loss and phase shift between the signal provided to the input port 318 and the scanner output signal received from the scanner output port 370. The test set 360 may also determine the reflection loss and phase of a signal component reflected back from the input port 318. The test set may measure the two-port S-parameters from the input port 318 of the AUT 310 to the scanner output port 370.

To test the AUT 310, the test set 360 may cause x-axis and y-axis positioners (not shown) within the near-field scanner 320 to sequentially move the field sampling probe 325 to a plurality of different measurement positions on a planar measurement surface. The near-field scanner 320 may be disposed such that the planar measurement surface is nearly normal to the beam 315 radiated by the AUT 310 and such that the measurement surface intercepts nearly all of the energy radiated by the AUT 310. When the field sampling probe 325 stops at each measurement position, the test set 360 may provide a signal at a frequency of interest to the input port 318 of the AUT 310. The AUT 310 may radiate the signal as the beam 315. The field sampling probe 325 may sample the electromagnetic field radiated by the AUT 310. The electrical signal induced in the field sampling probe 325 by the electromagnetic field may be coupled to the test set 360 via the scanner output port 370. At each test position, the test set 360 may sweep the frequency of the signal provided to the AUT 310 through a range of frequencies to enable measurement of frequency-dependent characteristics of the AUT 310.

The signal path from the field sampling probe 325 to the scanner output port 370 may include a waveguide portion 352 and a free-space quasi-optical transport path 350. As described in conjunction with FIG. 2, the phase and amplitude characteristics of free-space quasi-optical transport path 350 may change as the field sampling probe is moved to the plurality of measurement positions.

The test set 360 may determine the amplitude and phase of the signal received from the scanner output port 370. The amplitude and phase of the received signal may be compared to the amplitude and phase of the signal provided to the AUT input port 318 to extract amplitude and phase data indicating a change in amplitude and phase that occurred as the signal is transmitted through the AUT 310 and the field-field scanner 320 in sequence. The test set 360 may store the extracted amplitude and phase data for each of the plurality of measurement points. The test set may store extracted amplitude and phase data for a plurality of different frequencies for each of the plurality of measurement points.

To improve the accuracy of the measurements, the near-field scanner 320 may include a position sensing subsystem (not shown) to precisely measure the location of the field sampling probe 325 with respect to the AUT in three-dimensional space. Data from the position sensing system may be communicated to the test set 360 and may be stored along with the amplitude and phase data for each measurement position.

The test set 360 may not measure the characteristics of the AUT 310 directly, but may measure the characteristics of the AUT 310 in series with the near-field scanner 320. To determine the characteristics of the AUT 310 alone, the series combination of the AUT 310 and the near-field scanner 320 can be considered as a series combination of two two-port networks, identified in FIG. 3 as Network A and Network B.

Network A may be defined to include the AUT 310 and the field sensing probe 325. Amplitude and phase characteristics of the field sensing probe 325 in isolation may be accurately known and thus easily separated from the amplitude and characteristics of the AUT once amplitude and phase data for Network A are determined. The antenna input port 318 may be considered to be port 1 of Network A (Port 1A) and the juncture of the field sampling probe and the waveguide portion 352 may be considered to be port 2 of Network A (Port 2A).

Network B may include the transmission path from the field sampling probe 325 to the scanner output port 370. Network B may include the waveguide portion 352 and the free-space quasi-optical transport path 350. Since the phase and amplitude characteristics of the free-space quasi-optical transport path 350 may change as the field sampling probe is moved to the plurality of measurement positions, the characteristics of Network B may be determined by a series of calibration measurements. The juncture of the field sampling probe 325 and the waveguide portion 352 may be considered to be port 1 of Network B (Port 1B), and the scanner output port 370 may be considered to be port 2 of Network B (Port 2B).

Network A, Network B, and the series combination of Network A and B may be characterized by amplitude and phase data indicating the effect that the network has on the amplitude and phase of signals transmitted through the network from a first port to a second port. Each network may also be characterized by additional amplitude and phase data indicating the amplitude and phase of signals that are reflected from the first port and the second port. The amplitude and phase data may be expressed as a 2×2 matrix of parameters such as scattering parameters (S-parameters), transmission parameters (T-parameters), or other parameters. When testing an antenna using a near-field scanner, the amplitude and phase data for Network A, Network B, and the series combination of Network A and B will depend, in part, on the position of the field sensing probe 325 on the planar measurement surface. Additionally, the amplitude and phase data for each network may also depend, in part, on the frequency of the signal used to test the antenna.

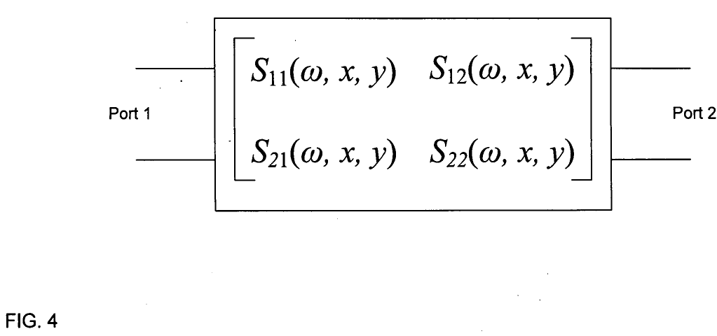

FIG. 4 shows a scattering matrix, or S-parameter matrix, for an exemplary 2-port network. Each of the four elements of the matrix may be frequency-dependent and position-dependent, which is to say that each of the four elements is a function of frequency and x and y position variables. The scattering matrix shown in FIG. 4 is typical of matrices that may be used to characterize Network A, Network B, and the series combination of Network A and B as shown in FIG. 3. However, for economy of notation, frequency and wavelength dependence is not shown, but should be inferred, in the subsequent analysis.

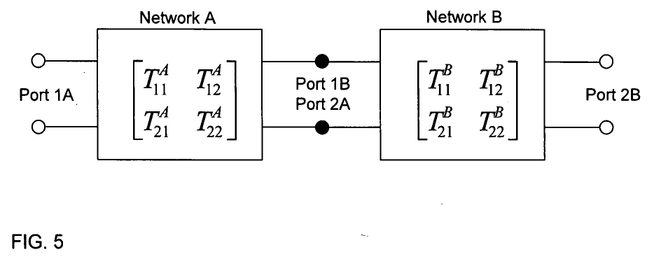

The series combination of Network A and Network B may be represented by a pair of cascaded 2×2 transmission matrices, as illustrated in FIG. 5. For each of the two-port Networks A and B, the elements of the transmission matrix are related to those of the corresponding scattering matrix as follows;

$$[ \begin{matrix}{T}_{11} & {T}_{12} \\ {T}_{21} & {T}_{22}\end{matrix} ] = [ \begin{matrix}\frac{1}{{S}_{21}} & - \frac{{S}_{22}}{{S}_{21}} \\ \frac{{S}_{11}}{{S}_{21}} & {S}_{12} - \frac{{S}_{11} {S}_{22}}{{S}_{21}}\end{matrix} ] .$$

A system of cascaded two-port networks may be represented by a transmission matrix that is the matrix product of the transmission matrices of the networks comprising the cascade. For example, for the system shown in FIG. 5, consisting of two networks labeled “A” and “B”, the transmission matrix of the system is given by

$$[ \begin{matrix}{T}_{11}^{AB} & {T}_{12}^{AB} \\ {T}_{21}^{AB} & {T}_{22}^{AB}\end{matrix} ] = [ \begin{matrix}{T}_{11}^{A} & {T}_{12}^{A} \\ {T}_{21}^{A} & {T}_{22}^{A}\end{matrix} ] [ \begin{matrix}{T}_{11}^{B} & {T}_{12}^{B} \\ {T}_{21}^{B} & {T}_{22}^{B}\end{matrix} ] , \qquad ( 1 )$$

where Tᵢⱼ^{AB} is the ij^{th} element of the transmission matrix for the two-port system consisting of Networks A and B in cascade, Tᵢⱼ^{A} is the ij^{th} element of the transmission matrix for Network A, and Tᵢⱼ^{B} is the ij^{th} element of the transmission matrix for Network B. The elements Tᵢⱼ^{B} of the transmission matrix for Network B may be determined by calibration measurements, which will be described in detail subsequently. The elements Tᵢⱼ^{AB} of the transmission matrix for the cascade of Networks A and B may be measured as previously described. The elements Tᵢⱼ^{A} of the transmission matrix for Network A may then be calculated by inverting equation (1) to obtain:

$$[ \begin{matrix}{T}_{11}^{A} & {T}_{12}^{A} \\ {T}_{21}^{A} & {T}_{22}^{A}\end{matrix} ] = {[ \begin{matrix}{T}_{11}^{AB} & {T}_{12}^{AB} \\ {T}_{21}^{AB} & {T}_{22}^{AB}\end{matrix} ] [ \begin{matrix}{T}_{11}^{B} & {T}_{12}^{B} \\ {T}_{21}^{B} & {T}_{22}^{B}\end{matrix} ]}^{- 1} = \frac{1}{{T}_{11}^{B} {T}_{22}^{B} - {T}_{12}^{B} {T}_{21}^{B}} [ \begin{matrix}{T}_{11}^{AB} {T}_{22}^{B} - {T}_{12}^{AB} {T}_{21}^{B} & {T}_{12}^{AB} {T}_{11}^{B} - {T}_{11}^{AB} {T}_{12}^{B} \\ {T}_{21}^{AB} {T}_{22}^{B} - {T}_{22}^{AB} {T}_{21}^{B} & {T}_{22}^{AB} {T}_{11}^{B} - {T}_{21}^{AB} {T}_{12}^{B}\end{matrix} ]$$

so that the elements of the transmission matrix for Block A are given by

$$\begin{matrix}{T}_{11}^{A} = \frac{{T}_{11}^{AB} {T}_{22}^{B} - {T}_{12}^{AB} {T}_{21}^{B}}{{T}_{11}^{B} {T}_{22}^{B} - {T}_{12}^{B} {T}_{21}^{B}} , \\ {T}_{12}^{A} = \frac{{T}_{12}^{AB} {T}_{11}^{B} - {T}_{11}^{AB} {T}_{12}^{B}}{{T}_{11}^{B} {T}_{22}^{B} - {T}_{12}^{B} {T}_{21}^{B}} , \\ {T}_{21}^{A} = \frac{{T}_{21}^{AB} {T}_{22}^{B} - {T}_{22}^{AB} {T}_{21}^{B}}{{T}_{11}^{B} {T}_{22}^{B} - {T}_{12}^{B} {T}_{21}^{B}} , \\ {T}_{22}^{A} = \frac{{T}_{22}^{AB} {T}_{11}^{B} - {T}_{21}^{AB} {T}_{12}^{B}}{{T}_{11}^{B} {T}_{22}^{B} - {T}_{12}^{B} {T}_{21}^{B}} .\end{matrix}$$

Finally, the S parameters for Network A may be calculated from the corresponding transmission matrix elements as follows:

$$\begin{matrix}{S}_{11}^{A} = \frac{{T}_{21}^{A}}{{T}_{11}^{A}} , \\ {S}_{12}^{A} = {T}_{22}^{A} - \frac{{T}_{12}^{A} {T}_{21}^{A}}{{T}_{11}^{A}} , \\ {S}_{21}^{A} = \frac{1}{{T}_{11}^{A}} , \\ {S}_{22}^{A} = - \frac{{T}_{12}^{A}}{{T}_{11}^{A}} .\end{matrix}$$

Thus, to extract the S-parameters for Network A, the elements of the transmission matrix for Network B must be known. However, a direct two-port measurement of Network B may not be practical.

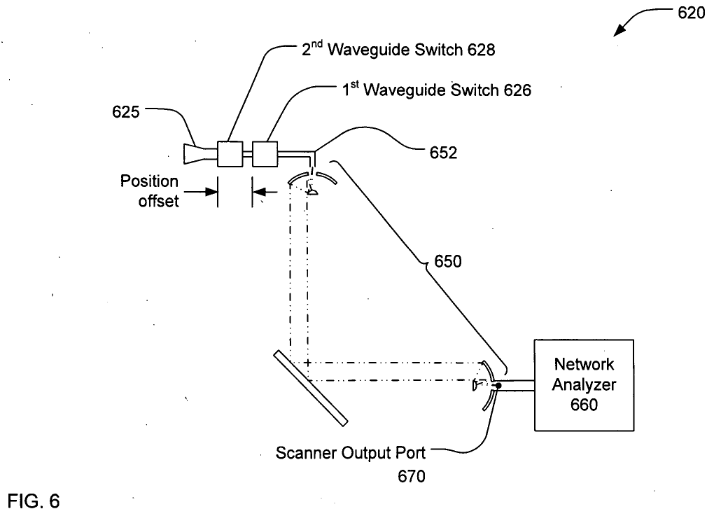

FIG. 6 is a block diagram of a modified near-field scanner 620, showing only the signal transmission path from a field sensing probe 625 to a scanner output port 670. The signal transmission path includes waveguide potion 652 to couple a signal from the field sensing probe 625 to a free-space quasi-optical beam transport path 650, which may be the free-space quasi-optical beam transport path 250 described in conjunction with FIG. 2. A first waveguide switch 626 and a second waveguide switch 628 may be connected in series in the waveguide portion 652 between the field sensing probe 625 and the free-space quasi-optical beam transport path 650. Each of the waveguide switches 626, 628 may have an open state in which the switch has near-zero insertion loss and near-zero reflection coefficient. Each of the waveguide switches 626, 628 may have a shorted state in which the switch functions as a short. The first switch 626 may be disposed to cause, in the shorted state, a short at a position proximate to the quasi-optical beam transport path 650. The position of the second switch 628 may be offset from the position of the first switch 626 such that the short created by placing the second switch in the shorted state is offset by a known distance from the short created by placing the first switch in the shorted state.

Incorporating the first waveguide switch 626 and the second waveguide switch 628 into the signal transmission path from the field sensing probe 625 to the scanner output port 670 may allow the variable-length free-space quasi-optical beam transport path 650 of the near-field scanner 620 to be characterized for each measurement position. Specifically, the S-parameters of the near-field scanner 620 may be determined by a series of reflection coefficient measurements at the scanner output port 670.

Description of Processes

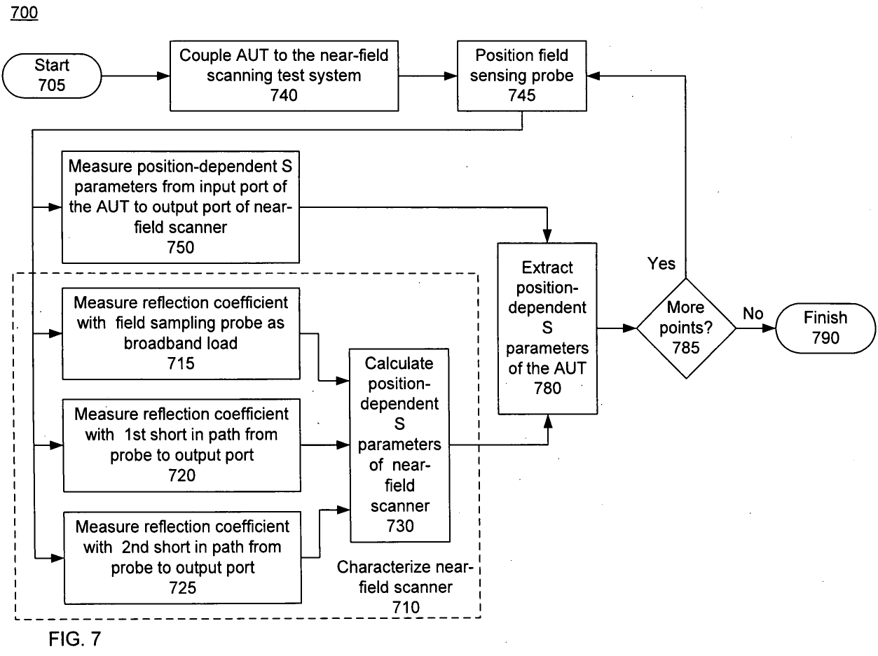

FIG. 7 is a flow chart of a process to test an antenna under test (AUT) using a near-field scanning test system, which may be the near-field scanning test system shown in FIG. 1. The near-field scanner, which may be the near field scanner 600, may include one or two switches, such as switches 626 and 628, to allow the near-field scanner to be characterized using a series of single-port measurements. While the process 700 is shown having a start 705 and a finish 790, the process is cyclic in nature, and the steps of the process may be repeated for each of a large plurality of test positions.

At 740, the AUT may be coupled to the near field scanning test system. The AUT may be positioned in proximity to the near field scanning test system such that at least a large portion of the energy radiated from the AUT passes through the measurement plane of the near field scanning test system. Further, measurements and/or calibration procedures may be undertaken to precisely determine the position of the near field scanning test system with respect to the AUT.

At 745, the field scanning probe of the near field measurement system may be moved to a predetermined measurement point, which may be one of a large number of intended measurement points.

The measurements performed at each measurement point may be comprised of three portions. At 710, the near-field scanner may be characterized by determining the position-dependent S-parameters or T-parameters of the transmission path through the near-field scanner from a field sampling probe to a scanner output port. At 750, the position-dependent S-parameters of a signal path through the AUT and the near-field scanner may be determined. At 780, the S parameters of the AUT as a function of position may be extracted from the results of 710 and 750.

At 710, the S-parameters of the transmission path from the scanner output port to the field sensing probe of the near-field scanner may be determined by measuring the reflection coefficient at the scanner output port under three conditions. At 715, a first reflection coefficient a may be measured with the first and second waveguide switches in the respective open states. In this case, the transmission path being measured is terminated by the field sensing probe, which may be assumed to be equivalent to a broadband matched load. At 720, a second reflection coefficient b may be measured with the first switch forming a short proximate to the quasi-optical beam transport path 650 and the second switch in the open state, such that the transmission path is terminated by a short at a first position. At 725, a third reflection coefficient c may be measured with the first switch in the open state and the second switch forming a short, such that the transmission path is terminated by a short at a second position offset from the first position by a known distance. The measurements at 715, 720, and 725 may be done in any order.

At 730, the S-parameters of the transmission path from the field sensing probe to the scanner output port may be calculated from the results of measurements at 715, 720, and 725. When a transmission path is terminated by a load having a known reflection coefficient Γ_{L} the reflection coefficient Γᵢₙ measured by a network analyzer coupled to the scanner output port 670 will be given by

$${Γ}_{in} = {S}_{11}^{B} + \frac{{S}_{21}^{B} {S}_{12}^{B} {Γ}_{L}}{1 - {S}_{22}^{B} {Γ}_{L}} . \qquad ( 2 )$$

Since the transmission path from the field sensing probe to the scanner output port of a near-field scanner is passive, S₂₁^{B}=S₁₂^{B}.

At 715, the first measurement may be made with the first and second waveguide switches 626, 628 in the respective open states. With the switches 626 and 628 open, the transmission path may be terminated by the field sensing probe, which may be assumed to be equivalent to a broadband matched load. In this case, Γ_{L}=0. Evaluating equation (2) for Γ_{L}=0, then

a=Γᵢₙ|_{Γ}_{₌₀}S₁₁^{B}. (3)

At 720, the second measurement may be made with the first switch 626 in a shorted state and the second switch 628 in an open state, such that the first switch 626 acts as a short at a first position proximate to the field sensing probe 625. In this case, Γ_{L}=−1. Evaluating equation (2) for Γ_{L}=−1, then

$$b = {Γ}_{in} {\vert}_{{Γ}_{L} = - 1} = {S}_{11}^{B} - \frac{{( {S}_{21}^{B} )}^{2}}{1 + {S}_{22}^{B}} = a - \frac{{( {S}_{21}^{B} )}^{2}}{1 + {S}_{22}^{B}} \qquad ( 4 )$$

At 725, the third measurement may be made with the first switch 626 in the open state and the second switch 628 in the shorted state, such that the second switch 628 acts as a short at a second position offset by a known distance from the first position. In this case, Γ_{L}=−e^{-j2β}^{₁₀}^{L}, where β₁₀ is the propagation constant in the transmission line connecting the first switch 626 and the second switch 628, and L is the distance between the two shorts. If the transmission line is rectangular waveguide, for example, the propagation constant is

$${β}_{10} = \sqrt{{β}^{2} - {β}_{c}^{2}} = \sqrt{{ω}^{2} μɛ - {( \frac{π}{w} )}^{2}} ,$$

where w is the width of the waveguide run that offsets the short from its original position.

Evaluating equation (2) for Γ_{L}=−e^{-j2β}^{₁₀}^{L}, then

$$c = {Γ}_{in} {\vert}_{{Γ}_{L} = - {e}^{- {j2β}_{10} L}} = {S}_{11}^{B} - \frac{{( {S}_{21}^{B} )}^{2} {e}^{- {j2β}_{10} L}}{1 + {S}_{22}^{B} {e}^{- {j2β}_{10} L}} = a - \frac{{( {S}_{21}^{B} )}^{2}}{{e}^{{j2β}_{10} L} + {S}_{22}^{B}} \qquad ( 5 )$$

For example, in a near-field scanner for use in the w-band (75-110 GHz) the first switch 626 and the second switch 628 may be connected by WR-10 waveguide with an offset distance L=0.042 inches. 0.042 inches is approximately one-quarter of the wavelength, in WR-10 waveguide, of a w-band signal. The distance L may be selected to be an odd multiple of one-quarter wavelength to maximize the difference between the measurements performed at 720 and 725. Equations (3), (4) and (5) can be manipulated to form

$$\begin{matrix}a - b = \frac{{( {S}_{21}^{B} )}^{2}}{1 + {S}_{22}^{B}} & ( 6 ) \\ and & \\ a - c = \frac{{( {S}_{21}^{B} )}^{2}}{{e}^{{j2β}_{10} L} + {S}_{22}^{B}} . & ( 7 )\end{matrix}$$

Taking the ratio of equations (6) and (7) yields

$$\frac{a - b}{a - c} = \frac{{e}^{{j2β}_{10} L} + {S}_{22}^{B}}{1 + {S}_{22}^{B}} . \qquad ( 8 )$$

Equation (8) can be solved for S₂₂^{B} to yield

$${S}_{22}^{B} = \frac{( a - c ) {e}^{{j2β}_{10} L} - ( a - b )}{( c - b )} . \qquad ( 9 )$$

Then from equations (6) and (9) (S₂₁^{B})² is given by

(S₂₁^{B})²=(a−b)(1+S₂₂^{B}). (10)

Taking the square root of Eq. (10), one obtains

S₂₁^{B}=±\sqrt{(a−b)(1+S₂₂^{B})}, (11)

which leaves a yet-to-be resolved sign ambiguity.

To resolve the sign ambiguity, define a normalized version of Eq. (11);

$${S}_{21 N}^{B} ( x , y ) = \frac{{S}_{21}^{B} ( x , y )}{{S}_{21}^{B} ( 0 , 0 )} , \qquad ( 12 )$$

where S₂₁^{B}(x, y) is obtained by evaluating Eq. (11) when the field-sampling probe is positioned at coordinates (x,y). If the beam transport system were ideal, such that the path had no loss and an accumulated phase shift due entirely to free-space plane-wave propagation, the ideal value of Eq. (12) would be

S₂₁I^{B}(x,y)=exp(−jβ₀(x+y)), (13)

where β₀ is the free-space wave number.

The phases calculated by Eqs. (12) and (13) will be very close except for the ±180° ambiguity of phase denoted by the ± sign in Eq. (11). The ambiguity is removed by choosing the phase for the result of Eq. (12) that most closely matches the phase of the result from Eq. (13). If we denote the ideal phase represented by Eq. 13 by Φ_{21I}(x, y), the unresolved phase of S₂₁^{B} by Φ_{21U}, and the resolved phase of S₂₁^{B} by Φ_{21R}(x, y), then

$$\begin{matrix}{Φ}_{21 I} ( x , y ) = - {β}_{0} ( x + y ) , & ( 14 a ) \\ {Φ}_{21 U} ( x , y ) = \frac{j}{2} Ln [ {( {S}_{21 N}^{B} ( x , y ) )}^{2} ] & ( 14 b )\end{matrix}$$

where Ln(z) is the principal value of the natural logarithm of z such that −π<Im(ln z)≦π, and

$${Φ}_{21 R} ( x , y ) = \{ \begin{matrix}{Φ}_{21 U} ( x , y ) if \vert {Φ}_{21 U} - {Φ}_{21 I} \vert \leq {90}^{∘} \\ {Φ}_{21 U} ( x , y ) + {180}^{∘} if \vert {Φ}_{21 U} - {Φ}_{21 I} \vert \geq {90}^{∘}\end{matrix} \qquad ( 14 c )$$

Note that the ideal phase Φ_{21I}(x, y) is calculated from a known value of β₀ and from measured values of x and y via Eq. (14a), while the unresolved phase Φ_{21U} is calculated from known values of L and β₁₀ and from measured values of a, b, and c via Eqs. (9) and (14b). Finally,

S₂₁^{B}(x,y)=\sqrt{|(a−b)(1+S₂₂^{B})}|exp[jΦ_{21R}(x,y)].

A simplified process for characterization of a near-field scanner may be used if an assumption is made that S₂₂=0. In this case,

S₁₁^{B}=a,

S₁₂^{B}=₂₁^{B}=|\sqrt{a−b}|exp[jΦ_{21R}(x,y)],

S₂₂^{B}=0.

where the phase Φ_{21R}(x, y) is resolved using the same process as in the three-step calibration procedure. When S₂₂ is assumed to be zero, the third measurement at 725 may not be required, and the second switch, 628 in FIG. 6, may not be required.

At 740, the AUT may be coupled to the near-field scanner. Specifically, an input port of the AUT may be coupled to the output of a transmitter within the near-field scanning test system. The AUT and the near-field scanner may be positioned such that the measurement plane of the near field scanner is proximate to the output of the AUT. The measurement plane of the near-field scanner may be disposed to intercept a large portion of the energy radiated by the AUT. The near-field scanner may be leveled if desired.

At 750, the S-parameters of the cascaded AUT and near-field scanner may be measured. The S-parameters from the input port of the AUT to the output port of the near-field scanner may be measured using conventional two-port vector measurement techniques.

At 780, the S-parameters of the AUT may be extracted from the results of the measurements at 710 and 750. The S-parameters of the AUT may be extracted by solving Eq. 1, using the results from 710 to determine the Tᵢⱼ^{B} parameters and the results from 750 to determine the Tᵢⱼ^{AB} parameters.

To fully measure the AUT, each of the portions 710, 750, 780 of the process 700 may be repeated with the field sensing probe of the near-field scanner in a plurality of locations on a measurement plane disposed adjacent to the AUT, as previously described. Thus at 785, a determination is made if measurements should be made at more locations. In the case that additional measurements are required, the process 700 may return to 745, where the field sensing probe may be positioned at the next measurement location. If all required measurements have been made, the process 700 may finish at 790.

Alternatively, the portions 710, 750, and 780 may be performed independently. For example, all of the measurements in portion 710 may be performed before or after all of the measurements in portion 750. However, this approach may introduce measurement errors if the field sensing probe cannot be repositioned at precisely the same locations for the measurements at 710 and 750.

The calculations at 780 may be then performed before or while the field sensing probe is moved to a next measurement position. The calculations at 780 may be done after all of the measurements at 710 and 750 have been completed, in which case the calculations at 780 would be performed after a decision at 785 that no more measurements are required and before the finish at 790.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. An apparatus to test an antenna, comprising:
a near-field scanner, comprising:
a field sampling probe to capture electromagnetic energy radiated by an antenna under test
an x-y positioning system including x and y positioning motors to move the field sampling probe over a measurement surface disposed proximate to the antenna under test
a quasi-optical beam transport system to couple at least a portion of the captured electromagnetic energy from the field sampling probe to a scanner output port
a transmitter to generate a test signal radiated by the antenna under test
a receiver coupled to the scanner output port.

2. The millimeter-wave near-field scanner of claim 1, the quasi-optical beam transport system further comprising:
a first antenna to accept electromagnetic energy captured by the field sampling probe and to transmit the electromagnetic energy as a collimated beam
a mirror to reflect the collimated beam
a second antenna to receive the collimated beam reflected from the mirror and to couple the electromagnetic energy to the scanner output port.

3. The millimeter-wave near-field scanner of claim 2 wherein
the first antenna is a reflective telescope coupled to the field sampling probe
the second antenna is a reflective telescope coupled to the receiver.

4. The millimeter-wave near-field scanner of claim 3 wherein at least one of the first antenna and the second antenna is a Cassegrain reflecting telescope.

5. The millimeter-wave near-field scanner of claim 2, wherein
the first antenna transmits the collimated beam in a direction parallel to a y-axis of the x-y positioning system
the mirror reflects the collimated beam in a direction parallel to an x-axis of the x-y positioning system.

6. The millimeter-wave near-field scanner of claim 2, further comprising a first switch coupled between the field sampling probe and the first antenna.

7. The millimeter-wave near-field scanner of claim 6, wherein the first switch has an open state and a shorted state in which the first switch functions as a short at a first location.

8. The millimeter-wave near-field scanner of claim 7, further comprising:
a second switch coupled between the field sampling probe and the first antenna in series with the first switch
wherein the second switch has an open state and a shorted state in which the second switch functions as a short at a second location offset in position with respect to the first location.

9. The millimeter-wave near-field scanner of claim 1, further comprising an x-y position sensing system to precisely determine the position of the field sampling probe with respect to the antenna under test.

10. The millimeter-wave near-field scanner of claim 9,
wherein the x-y position sensing system is a laser tracker, and
wherein at least one reflector is attached to the field sampling probe to allow the laser tracker to precisely track the position of the field sampling probe with respect to the antenna under test.

11. The millimeter-wave near-field scanner of claim 1, further comprising a controller to control the x-y positioning system, the first switch, and the second switch and to cause measurement data from the receiver to be stored.

12. A process for testing an antenna using a near field scanner including a field sampling probe, the process comprising:
(a) measuring amplitude and phase data for a first transmission path from an input port of the antenna through the field sampling probe to an output port of the near-field scanner
(b) determining amplitude and phase data for a second transmission path from the field sampling probe to the output port of the near-field scanner
(c) extracting amplitude and phase characteristics of a third transmission path from the input port of the antenna to the field sampling probe using the data from (a) and (b)
wherein the amplitude and phase data for the second transmission path is determined via a single-port measurement process including a plurality of reflection measurements made at the output port of the near-field scanner.

13. The process for testing an antenna of claim 12, further comprising:
(d) repeating (a)-(c) at each of the plurality of positions to determine position-dependent amplitude and phase data for the third transmission path.

14. The process for testing an antenna of claim 12, the single port measurement process further comprising:
(b1) measuring a first complex reflection coefficient a at the output port of the near-field scanner with the field sampling probe acting as a broadband load
(b2) measuring a second complex reflection coefficient b at the output port of the near-field scanner with a first waveguide switch implementing a first short in the transmission path from the sampling probe to the output port of the near-field scanner and with a second waveguide switch in an open state
(b3) measuring a third complex reflection coefficient c at the output port of the near-field scanner with the first waveguide switch in an open state and with the second waveguide switch implementing a second short in the transmission path from the sampling probe to the output port of the near-field scanner, wherein a location of the second short is offset with respect to a location of the first short
(b4) calculating the S parameters of the transmission path from the field sampling probe to the output port of the near-field scanner from the first, second, and third complex reflection coefficients.

15. The process for testing an antenna of claim 14, wherein calculating the S parameters of the transmission path from the field sampling probe to the output port of the near-field scanner uses the equations:
$$\begin{matrix}{S}_{11} = a \\ {S}_{22} = \frac{( a - c ) {e}^{{j2β}_{10} L} - ( a - b )}{( c - b )} \\ {S}_{21} = \pm \sqrt{( a - b ) ( 1 + {S}_{22} )} and \\ {S}_{21} = {S}_{12}\end{matrix}$$
wherein β₁₀ is the propagation constant in the transmission line connecting the first waveguide switch and the second waveguide switch, and L is the offset distance between the first short and the second short.

16. The process for testing an antenna of claim 15, wherein the sign ambiguity in the equation for S₂₁ is resolved by evaluating the equation:
Φ₂₁I(x,y)=exp(−jβ₀(x+y)),
wherein β₀ is the propagation constant of free space, and x+y is a path length of the quasi-optical beam transport system.

17. The process for testing an antenna of claim 12, the single port measurement process further comprising:
(c1) measuring a first complex reflection coefficient a at the output port of the near-field scanner with the field sampling probe acting as a broadband load
(c2) measuring a second complex reflection coefficient b at the output port of the near-field scanner with a first waveguide switch implementing a first short in the transmission path from the sampling probe to the output port of the near-field scanner
(c3) calculating the S parameters of the transmission path from the field sampling probe to the output port of the near-field scanner from the first and second complex reflection coefficients.

18. The process for testing an antenna of claim 17, wherein calculating the S parameters of the transmission path from the field sampling probe to the output port of the near-field scanner uses the equations:
S₁₁=a
S₂₂=0
S₂₁=±\sqrt{(a−b)} and
S₂₁=S₁₂.

19. The process for testing an antenna of claim 19, wherein the sign ambiguity in the equation for S₂₁ is resolved by evaluating the equation:
Φ₂₁I(x,y)=exp(−jβ₀(x+y)),
wherein β₀ is the propagation constant of free space, and x+y is a path length of the quasi-optical beam transport system.
